(19) United States
(12) Patent Application Publication
(10) Pub. No.: US 2014/0185613 A1
(43) Pub. Date: Jul. 3, 2014

(54) MULTIPLE PATH CONTROL FOR MULTICAST COMMUNICATION

(71) Applicant: FUJITSU LIMITED, Kawasaki-shi (JP)

(72) Inventor: Masahiro Sato, Yokohama (JP)

(73) Assignee: FUJITSU LIMITED, Kawasaki-shi (JP)

(21) Appl. No.: 14/061,239

(22) Filed: Oct. 23, 2013

(30) Foreign Application Priority Data
Dec. 28, 2012 (JP) 2012-288015

(51) Int. Cl. H04L 12/18; H04L 12/741

(52) U.S. Cl. CPC H04L 12/18; H04L 45/74
USPC 370/390

(57) ABSTRACT

An apparatus serves as a node connected to a communication network in which multiple paths are provisioned by using a plurality of transfer apparatuses each configured to perform snooping on a transferred message. When participating in a multicast group, the apparatus selects, from among the plurality of transfer apparatuses, at least one first transfer apparatus each including a plurality of first ports configured to receive a first message addressed to nodes belonging to the multicast group. Then, the apparatus acquires a plurality of transfer paths via which the first message is to be transferred, by generating, for each of the first ports provided for the at least one first transfer apparatus, a second message requesting participation in the multicast group, and transmitting the generated second message to the at least one first transfer apparatus so that the second message is transferred via the each of the first ports.

### CROSS-REFERENCE TO RELATED APPLICATION

This application is based upon and claims the benefit of priority of the prior Japanese Patent Application No. 2012-288015, filed on Dec. 28, 2012, the entire contents of which are incorporated herein by reference.

### FIELD

The embodiment discussed herein is related to a technique for multiple path control for multicast communication.

### BACKGROUND

In recent years, with the expansion of networks, services for users that connect, as nodes, information processing apparatuses (computers) to a network have been widely provided. Nowadays, the widening of bandwidth in networks allows a wider range of services to be provided. Here, for convenience of explanation, a node refers to an information processing apparatus operated by a user for which services are provided.

One of the services is a distribution service of images, sounds, or the like. The distribution service may be roughly classified into an individual audio-visual service in which data is transmitted to an individual and a group audio-visual service in which the same data is transmitted to people belonging to a specific group simultaneously. In many group audio-visual services, multicast transmission is now adopted.

As a transmission scheme capable of transmitting the same data to a plurality of nodes simultaneously, broadcast transmission is provided. In broadcast transmission, switches (transfer apparatuses) located on transfer paths, through which data is transferred, each transfer data from all ports. On the other hand, in multicast transmission, switches located on transfer paths, through which data is transferred, each transfer data from only a certain port. Hence, in comparison with the broadcast transmission, the multicast transmission may transmit data more efficiently while suppressing inefficient use of a frequency bandwidth. In view of this advantage, group audio-visual services which adopt the multicast transmission are increasing in number.

An Internet group management protocol (IGMP) is typically used for control of multicast transmission. The IGMP may cause a router to recognize a node belonging to a multicast group. Hereinafter, the node that belongs to the multicast group is referred to as a “group node” so as to distinguish it from others.

A node that wants to participate in the multicast group transmits a message called an IGMP report to the router. Each switch snoops on the message transmitted from the node, recognizes a group node that exists under the switch, and causes a multicast table to reflect the recognition result.

In the multicast table, entries (records) in which recognition results are stored are prepared. In each entry, there are stored, as each recognition result, a multicast address which is allocated to the multicast group, and identification information of a port that transmits a message addressed to the group node, whose destination Internet protocol (IP) address is the multicast address. Hereinafter, the identification information of the port is assumed to be a port number. The port that transmits a message addressed to the group node is a port that receives the IGMP report. The IGMP report is also called an IGMP join message. Hereinafter, a message addressed to the group node is referred to as a “multicast message”.

When each switch receives a multicast message transmitted from the router, the switch refers to the multicast table and determines to which one of ports the multicast message is to be transferred or not. As for the port for transfer of the received multicast message, the port number of the port and the multicast address are stored as an entry in the multicast table. Thus, useless transfer of the multicast message is avoided, thereby suppressing inefficient use of a bandwidth.

The switch is typically configured to detect a failure that has occurred in a network due to a break in a cable, a failure of another transfer apparatus, or the like, and to switch a communication path for a message, that is, to switch ports that transmit the message. In a network in which multiple paths are implemented, in many cases, switching between the ports may be performed. In the case of switching between paths caused by a failure occurrence, a switch to which a multicast message is to be transferred is changed.

A multicast message is transferred in reverse through a transfer path through which an IGMP report is transferred. Hence, when a switch to which a multicast message is to be transferred is changed, an entry corresponding to the multicast message does not exist in the multicast table of a switch to which the multicast message is newly to be transferred. The multicast message whose corresponding entry does not exist in the multicast table is discarded. As a result, some group nodes may not be able to receive the multicast message due to a failure in a network. In view of this, it is desirable to deliver the multicast message to each group node more reliably even if a failure occurs in the network.

Japanese Laid-open Patent Publication No. 2006-246264 is an example of related art.

### SUMMARY

According to an aspect of the invention, an apparatus serves as a node connected to a communication network in which multiple paths are provisioned by using a plurality of transfer apparatuses each configured to perform snooping on a transferred message. When participating in a multicast group, the apparatus selects, from among the plurality of transfer apparatuses, at least one first transfer apparatus each including a plurality of first ports configured to receive a first message addressed to nodes belonging to the multicast group. Then, the apparatus acquires a plurality of transfer paths via which the first message is to be transferred, by generating, for each of the first ports provided for the at least one first transfer apparatus, a second message requesting participation in the multicast group, and transmitting the generated second message to the at least one first transfer apparatus so that the second message is transferred via the each of the first ports.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a topology of a network to which an information processing apparatus is connected, according to an embodiment;

FIG. 2 is a diagram illustrating an example of a functional configuration of an information processing apparatus, according to an embodiment.

FIG. 3 is a diagram illustrating an example of an operation performed by a switch when a link aggregation (LAG) setting is enabled, according to an embodiment;

FIG. 4 is a diagram illustrating an example of transfer paths through which an Internet group management protocol (IGMP) query transmitted from a router is transferred to each host, according to an embodiment;

FIG. 5 is a diagram illustrating an example of an IGMP report transmitted by a host participating in a multicast group, according to an embodiment;

FIG. 6 is a diagram illustrating an example of a configuration of an IGMP message, according to an embodiment;

FIG. 7A is a diagram illustrating an example of information obtained from a switch by using a constitution information check command, according to an embodiment;

FIG. 7B is a diagram illustrating an example of information obtained from a switch by using a distribution check command, according to an embodiment;

FIG. 8 is a diagram illustrating an example of an operational flowchart for an IGMP message management table creation process, according to an embodiment;

FIG. 9 is a diagram illustrating an example of an operational flowchart for an IGMP message generation process, according to an embodiment;

FIG. 10 is a diagram illustrating an example of an operational sequence for a host and a network connected with the host, according to an embodiment; and

FIG. 11 is a diagram illustrating an example of a configuration of an information processing apparatus, according to an embodiment.

### DESCRIPTION OF EMBODIMENT

An embodiment will be described below in detail with reference to the drawings.

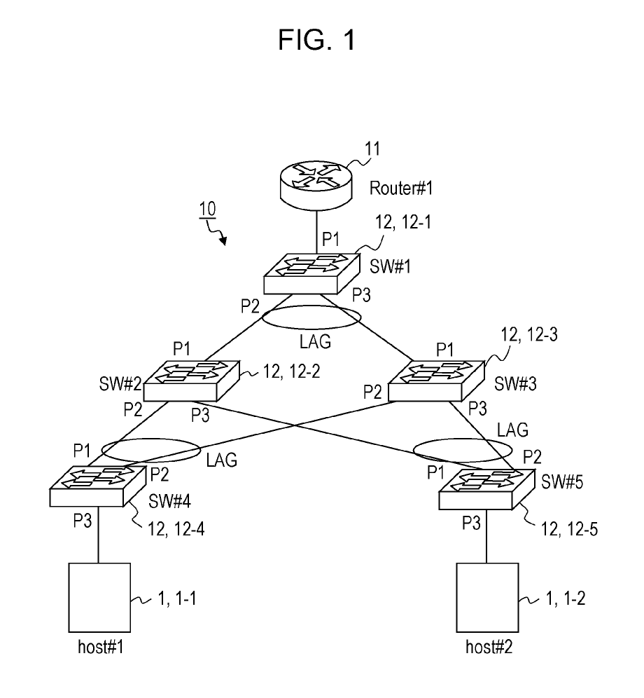

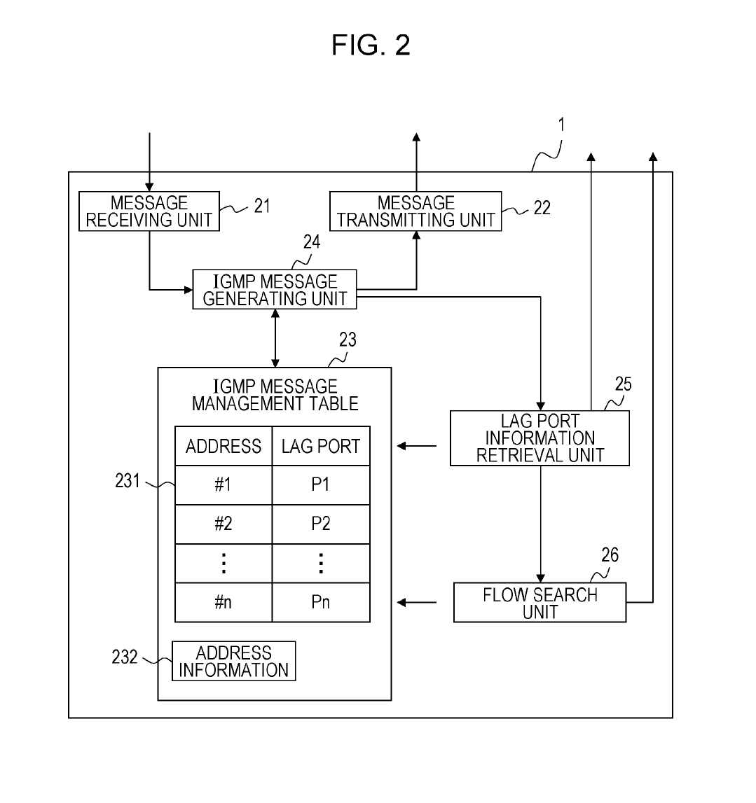

FIG. 1 is a diagram illustrating an example of a topology of a network to which an information processing apparatus is connected, according to an embodiment. FIG. 2 is a diagram illustrating an example of a functional configuration of an information processing apparatus, according to an embodiment.

As illustrated in FIG. 1, a network 10 includes a router 11 and a plurality of switches 12. For ease of understanding, FIG. 1 illustrates only five switches 12-1 to 12-5 as the switches 12 that constitute the network 10.

1 (1-1 and 1-2) indicated in FIG. 1 denote information processing apparatuses (computers) according to an embodiment. In FIG. 1, the information processing apparatuses are denoted as “host #1” and “host #2”. Hereinafter, the information processing apparatuses 1 (1-1 and 1-2) according to the embodiment are referred to as hosts. The hosts 1-1 and 1-2 are connected to the switches 12-4 and 12-5, respectively.

Here, data transferred on the network 10 is referred to as a “packet”. A packet transferred from the router 11 to the hosts 1 belonging to a multicast group is referred to as a “multicast packet”.

“P1” to “P3” indicated in FIG. 1 each denote one of a plurality of ports provided in each switch 12. For example, “P1” denotes a port whose port number is 1. Thus, since “P1” to “P3” each denote identification information representing only one port, hereinafter, “P1” to “P3” will be used as reference numerals of identifiable ports.

“LAG” indicated in FIG. 1 is an abbreviation of link aggregation. LAG is a technique in which a plurality of physical ports are combined together into one logical port in a virtual manner and are dealt with as one logical port. In the example illustrated in FIG. 1, in the switch 12-1, the ports P2 and P3 are defined as one logical port by using LAG, and, in each of the switches 12-4 and 12-5, the ports P1 and P2 are defined as one logical port by using LAG.

In the example illustrated in FIG. 1, the number of ports of each switch 12 is three. For this reason, in each of the switches 12-1, 12-4, and 12-5, the number of ports that constitute a LAG group is two. However, all the switches 12 do not have to have an equal number of ports. The switches 12 that employ LAG and the number thereof are not particularly limited.

Between the switches 12, the ports P1, P2, and P3 of the switch 12-1 are connected to the router 11, the port 1 of the switch 12-2, and the port 1 of the switch 12-3, respectively. The ports P2 and P3 of the switch 12-2 are connected to the port P1 of the switch 12-4 and the port P1 of the switch 12-5, respectively. The ports P2 and P3 of the switch 12-3 are connected to the port P2 of the switch 12-4 and the port P2 of the switch 12-5, respectively. The port P3 of the switch 12-4 is connected to the host 1-1. The port P3 of the switch 12-5 is connected to the host 1-2. Based on the above mentioned connection relationship, the network 10 is configured to include multiple paths that enable a message to be transferred between the router 11 and each host 1 via a plurality of transfer paths.

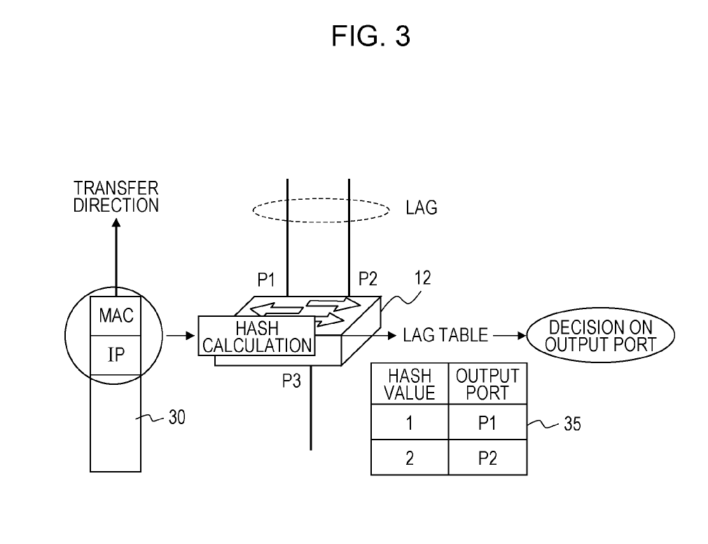

FIG. 3 is a diagram illustrating an example of an operation performed by a switch when a LAG setting is enabled, according to an embodiment. Here, an operation for distribution of a packet 30 performed by the switch 12 in which a LAG setting is enabled will be described with reference to FIG. 3.

The packet 30 is roughly divided into a header portion and a data portion. In the header portion, a destination address (DA) and a source address (SA) are stored. The destination address and the source address each have two addresses: an Internet protocol (IP) address and a media access control (MAC) address. An IGMP message is stored in the data portion.

In the switch 12 illustrated in FIG. 3, the port P1 and the port P2 are combined together by LAG. The packet 30 received via the port P3 is thereby transmitted via either the port P1 or the port P2. A LAG table 35 illustrated in FIG. 3 is used for selection of a distribution destination of the packet 30.

The LAG table 35 includes entries, the number of which is at least the number of ports for which a LAG is set. In each entry, a hash value and identification information that represents a port used for transmission of the packet 30 are stored. In FIG. 3, “P1” and “P2” each denote identification information of the port.

The switch 12 having received the packet 30 via the port P3 extracts a plurality of addresses stored in the header portion of the packet 30 and calculates a hash value by using the extracted plurality of addresses. The switch 12 subsequently refers to the LAG table 35 by using the calculated hash value, identifies an entry in which the hash value is stored, and determines that a port whose identification information is stored in the entry is to be used as a port for transmission of the packet 30. One of the plurality of ports combined together by LAG is therefore used for transmission of the packet 30. Because such distribution of the packet 30 is implemented, LAG is used for controlling multiple paths.

Each switch 12 on the network 10 may be configured to enable a LAG setting and snooping. When the snooping is enabled, each switch 12 performs snooping.

As illustrated in FIG. 2, the host 1 serving as the information processing apparatus according to an embodiment includes a message receiving unit 21, a message transmitting unit 22, a storage unit 23, an IGMP message generating unit 24, a LAG port information retrieval unit 25, and a flow search unit 26. The storage unit 23 stores an IGMP message management table 231 and address information 232. These will be described in detail later.

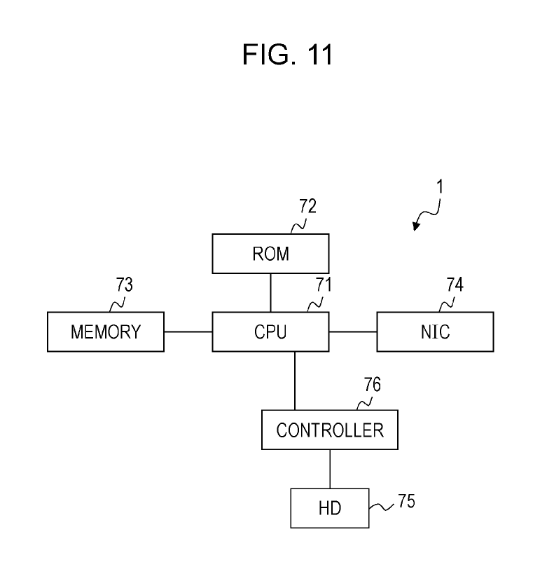

FIG. 11 is a diagram illustrating an example of a configuration of an information processing apparatus, according to an embodiment. As illustrated in FIG. 11, the host 1 serving as the information processing apparatus according to the embodiment includes a central processing unit (CPU) 71, a read only memory (ROM) 72, a memory (memory module) 73, a network interface card (NIC) 74, a hard disk device (HD) 75, and a controller 76. This configuration is an example and the configuration of the host 1 is not limited to this.

The ROM 72 is a memory that stores a basic input/output system (BIOS). The BIOS is read into the memory 73 and executed by the CPU 71. The hard disk device 75 stores an operating system (OS) and various application programs (hereinafter abbreviated as “apps”). After the BIOS has finished booting up, the CPU 71 may read the OS from the hard disk device 75 via the controller 76 and execute the OS. Activation of the OS enables communication via the NIC 74.

The message receiving unit 21 and the message transmitting unit 22 which are illustrated in FIG. 2 correspond to the NIC 74 illustrated in FIG. 11. The storage unit 23 corresponds to the memory 73, or alternatively the memory 73 and the hard disk device 75. The IGMP message generating unit 24, the LAG port information retrieval unit 25, and the flow search unit 26 are implemented by the CPU 71 executing corresponding programs read from the hard disk device 75 into the memory 73 via the controller 76.

The programs that implement the IGMP message generating unit 24, the LAG port information retrieval unit 25, and the flow search unit 26 may be different from one another. In the case where the respective programs that implement the IGMP message generating unit 24, the LAG port information retrieval unit 25, and the flow search unit 26 are defined as sub-programs, the sub-programs may be combined into one program. Thus, a method of installing the programs that implement the IGMP message generating unit 24, the LAG port information retrieval unit 25, and the flow search unit 26 is not limited. Here, for convenience of explanation, it is assumed that those programs are incorporated in the OS.

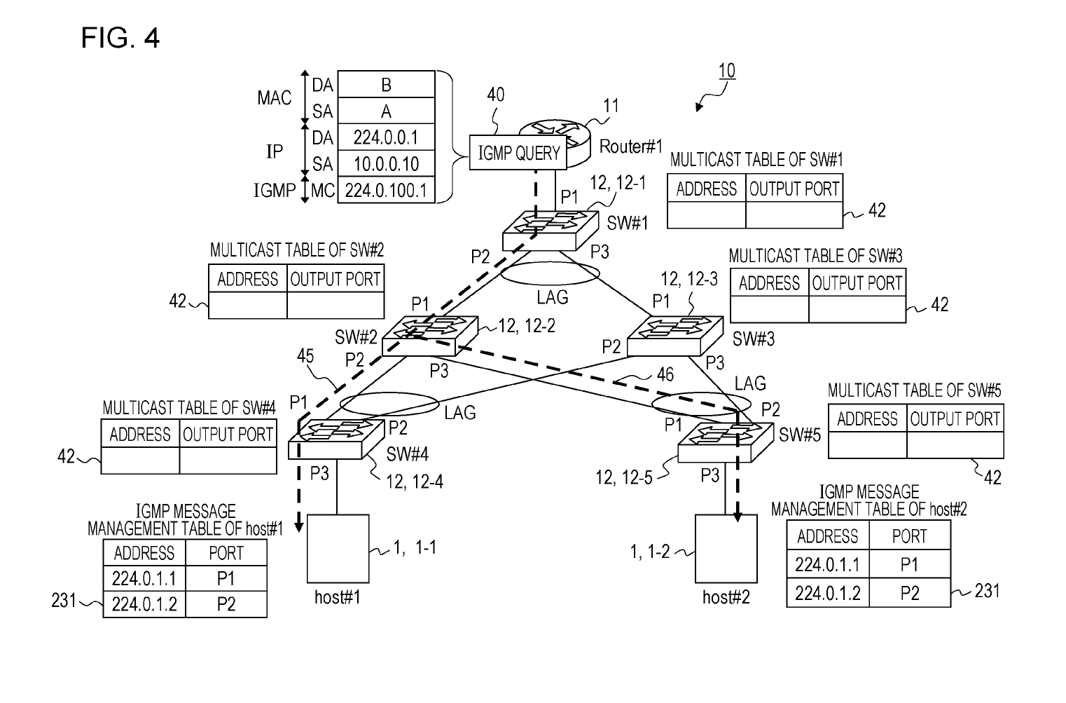

Next, an operation performed by the host 1 having, as an example, the functional configuration illustrated in FIG. 2 will be described below with reference to FIGS. 4 to 7B.

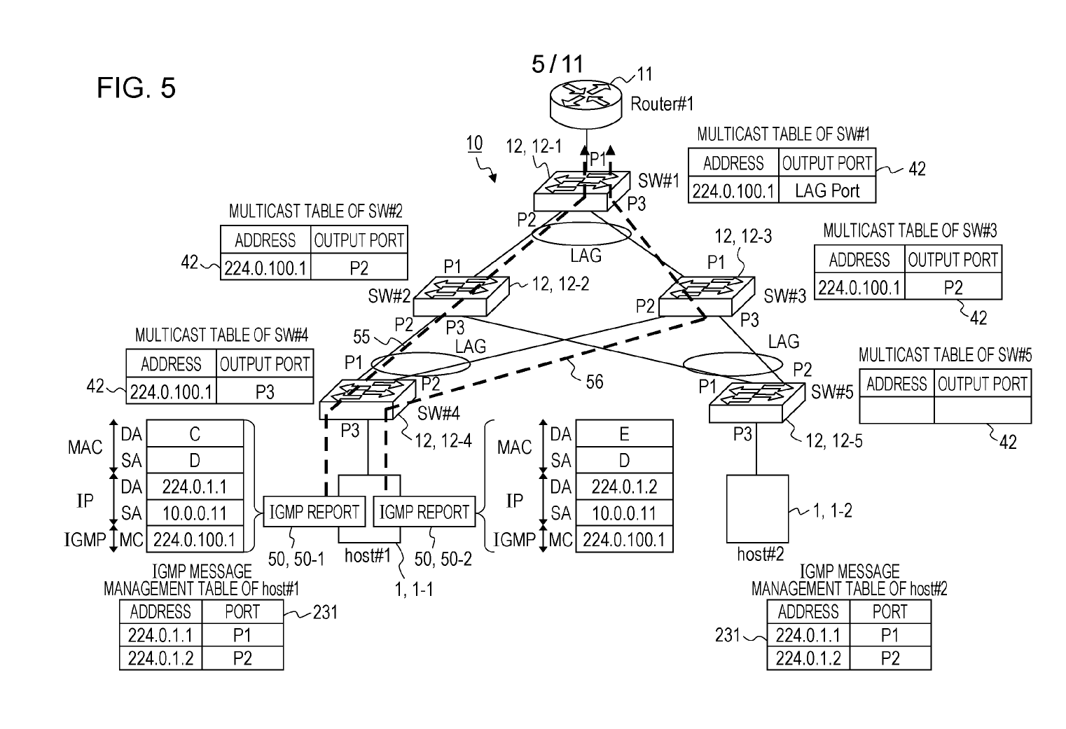

FIG. 4 is a diagram illustrating an example of transfer paths through which an IGMP query transmitted from a router is transferred to each host, according to an embodiment. An IGMP query 40 here refers to a packet 30 that stores an IGMP query in the data portion, unless otherwise noted. An IGMP query itself stored in the data portion of the IGMP query 40 is referred to as an “original IGMP query”. Similarly, an IGMP report 50 illustrated in FIG. 5 refers to a packet 30 that stores an IGMP report, unless otherwise noted. A primary IGMP report is referred to as an “original IGMP report”. The reference numeral “30” is not used for a multicast packet so as to distinguish it from other packets 30.

The router 11 transmits a message so as to check, for example, the existence of the host 1 belonging to the multicast group. The IGMP query 40 is a packet for the message. In the IGMP query 40 illustrated in FIG. 4, “A” denotes a MAC address (source address (SA)) of the router 11, “224.0.100.1” denotes a multicast address, and “B” denotes a MAC address for 224.0.100.1.

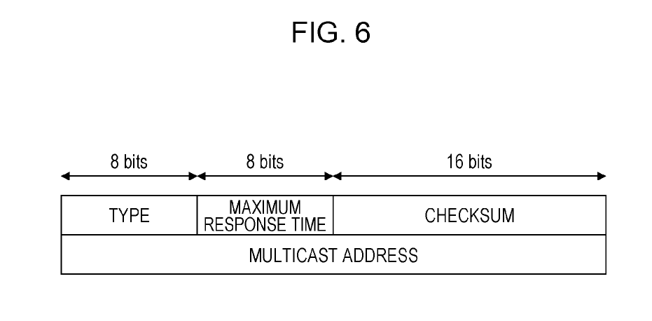

FIG. 6 is a diagram illustrating an example of a configuration of an IGMP message, according to an embodiment. The IGMP message illustrated in FIG. 6 is an original IGMP message stored in the data portion of a packet 30. As illustrated in FIG. 6, the original IGMP message includes a type, a maximum response time, a checksum, and a multicast address.

The type denotes a type of the original IGMP message. The type of the original IGMP message is identified as, for example, an IGMP query, an IGMP report, or the like.

The maximum response time is data effective in the case of the IGMP query. The checksum is used for checking the integrity of the original IGMP message. The multicast address is data effective in the case of the IGMP report and denotes a multicast address of the multicast group in which the host 1 wants to participate.

The switch 12 in which snooping is enabled snoops on an IGMP report transmitted from the host 1 existing under the switch 12 (on the side to which a packet 30 is transferred from the router 11) and updates a multicast table 42 in accordance with the snooping result. In an entry (record) that constitutes the multicast table 42, there are stored a multicast address that is allocated to the multicast group and a port number of a port that transmits a multicast packet storing the multicast address. Thus, the switch 12 in which snooping is enabled refers to the multicast table 42 and performs transfer to only the port via which the transfer is to be performed. In FIG. 4, for convenience of explanation, it is assumed that there exists no entry in which a combination of a multicast address and a port number is stored, in the multicast table 42 managed by each switch 12.

The IGMP query 40 transmitted from the router 11 is transferred to each host 1 through transfer paths 45 and 46 as indicated by dashed arrows in FIG. 4. These transfer paths 45 and 46 correspond to transfer paths through which the IGMP report 50 transmitted from each host 1 is transferred. In the configuration of the network 10 illustrated in FIG. 4, when a failure of transfer of the packet 30 from the switch 12-1 to the switch 12-2 occurs, the packet 30 is transferred from the switch 12-1 to the switch 12-3. Consequently, the transfer paths used between the switch 12-1 and the hosts 1-1 and 1-2 are respectively changed as follows: the switch 12-1→the switch 12-3→the switch 12-4→the host 1-1, and the switch 12-1→the switch 12-3→the switch 12-5→the host 1-2. Under circumstances where each host 1 belongs to the multicast group, a multicast packet may fail to be delivered to each host 1 due to such a change of transfer paths. In view of this, in the embodiment, a plurality of transfer paths are secured for the host 1 that participates in the multicast group. Securing of the plurality of transfer paths may reduce the possibility that the multicast packet fails to be delivered to the host 1.

The IGMP message management table 231 stored in the storage unit 23 is a table that is created so as to secure a plurality of transfer paths. As illustrated in FIGS. 2 and 4, in each entry in the IGMP message management table 231, an address and a port number are stored. The address is a multicast address. The port number is a port number identifying a port provided in the switch 12 that transmits and receives a packet 30 directly to and from each host 1. Thus, for example, when the host 1 is the host 1-1, the switch 12 is the switch 12-4. FIG. 4 illustrates a state after each host 1 has created the IGMP message management table 231.

The LAG port information retrieval unit 25 checks a port which is likely to become a distribution destination in the switch 12 directly connected to the host 1. The port number stored in each entry in the IGMP message management table 231 is obtained as a check result by the LAG port information retrieval unit 25.

In a network in which multiple paths are implemented, a LAG setting is typically enabled in a switch directly connected to a host. For this reason, a port to be checked by the LAG port information retrieval unit 25 is typically a port that constitutes a LAG group. However, it is not always necessary to set a LAG to the switch 12 directly connected to the host 1.

The flow search unit 26 checks, with respect to each port checked by the LAG port information retrieval unit 25, a multicast address to which a message is transmitted from the each port. The address stored in each entry in the IGMP message management table 231 is obtained as a check result by the flow search unit 26.

Checks made by the LAG port information retrieval unit 25 and the flow search unit 26 may each be performed by transmitting a certain command, based on a protocol, such as Telnet or secure shell (SSH). Here, commands transmitted by the LAG port information retrieval unit 25 and the flow search unit 26 are respectively referred to as a “constitution information check command” and a “distribution check command”. The address information 232 stored in the storage unit 23 is information for accessing the switch 12 directly connected to the host 1.

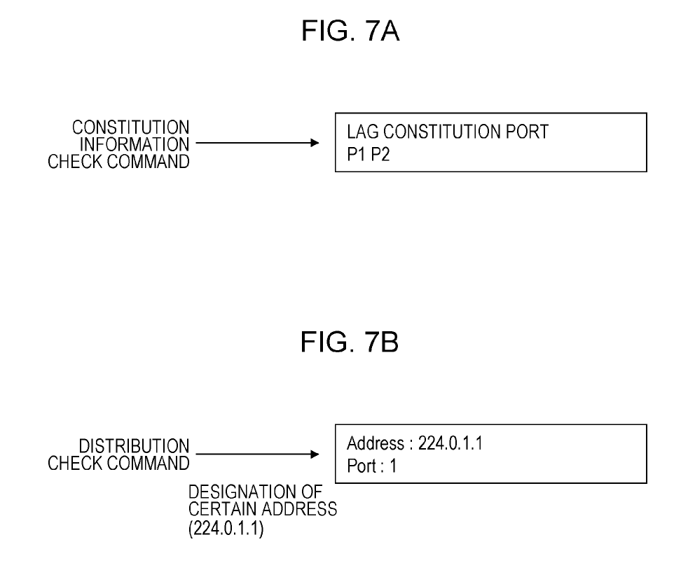

FIG. 7A is a diagram illustrating an example of information obtained from a switch by using a constitution information check command, according to an embodiment. FIG. 7B is a diagram illustrating an example of information obtained from a switch by using a distribution check command, according to an embodiment.

As illustrated in FIG. 7A, the switch 12 having received a constitution information check command provides, in return, a port number of each port which is usable as a distribution destination of the packet 30 received from the host 1. The port number obtained in return is stored in an entry in the IGMP message management table 231.

On the other hand, the distribution check command is a command for designating an address and checking a port number identifying a port to which the packet 30 storing the designated address is distributed. Hence, as illustrated in FIG. 7B, the switch 12 having received the distribution check command provides, in return, the port number identifying the port of the distribution destination.

“224.0.1.1” indicated in FIG. 7B is a multicast address that has been designated. In FIG. 7B, only the multicast address is indicated as a designated address. This is because, in the embodiment, among addresses that are able to be designated, only multicast addresses are subject to change, the content of a multicast address to be designated is changed, and a distribution destination based on an actual designated multicast address is checked. Thus, only a multicast address is stored as an address in each entry in the IGMP message management table 231.

FIG. 5 is a diagram illustrating an example of an IGMP report transmitted by a host participating in a multicast group, according to an embodiment.

As described above, in the IGMP message management table 231, an entry is prepared for each of ports serving as a distribution destination within the switch 12 directly connected to the host 1. Thus, the host 1 that participates in the multicast group generates an IGMP report 50 for each entry and transmits the generated IGMP report 50.

Two IGMP reports 50 (50-1 and 50-2) illustrated in FIG. 5 are reports for requesting participation in the same multicast group. Hence, in each IGMP report 50, a multicast address (MC) in an original IGMP report, labeled “IGMP” in FIG. 5, is the same “224.0.100.1”. However, since IP addresses serving as destination addresses (DA) are different, MAC addresses serving as destination addresses are also different. “D”, which represents a MAC address serving as a source address, denotes a MAC address of the host 1-1.

The two IGMP reports 50 are respectively transferred to the router 11 through transfer paths 55 and 56 indicated by dashed arrows. Each switch 12 on the transfer paths 55 and 56 updates the multicast table 42 managed by itself by snooping on the received IGMP report 50. Consequently, the host 1-1 may receive any multicast packet transferred in reverse through each of the transfer paths 55 and 56.

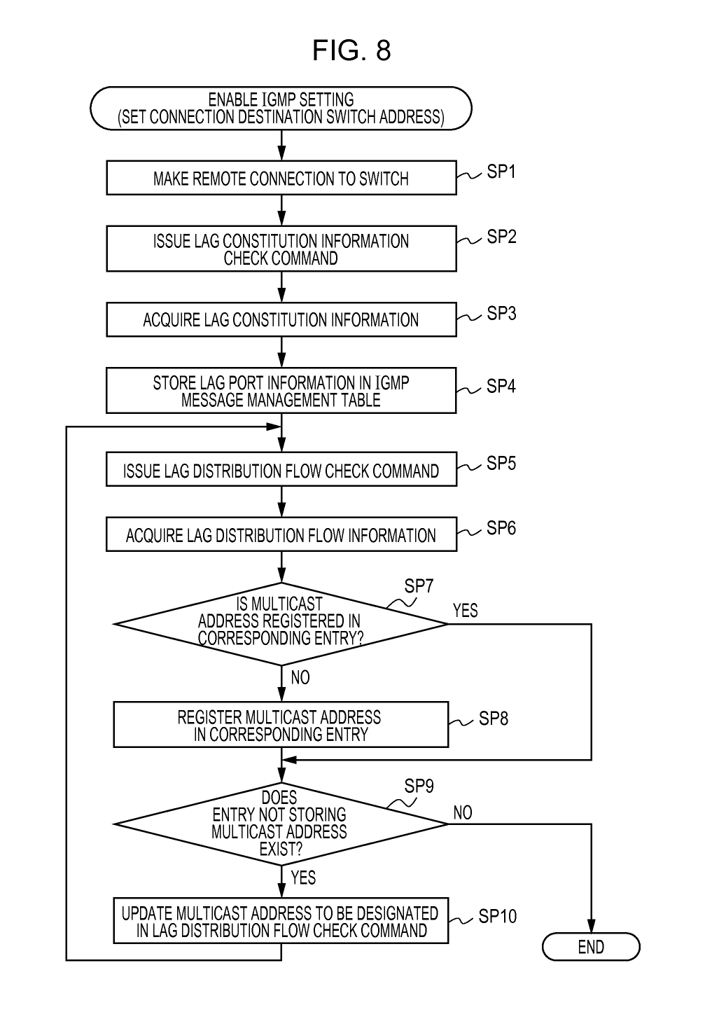

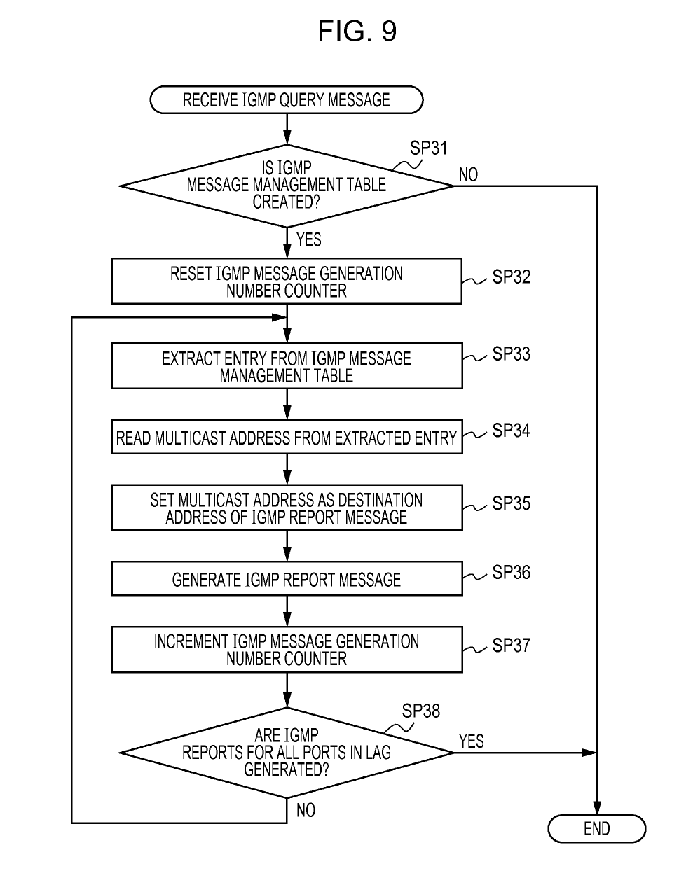

Creation of the IGMP message management table 231 and generation of the IGMP report 50 are implemented by the CPU 71 executing the OS stored in the hard disk device 75. Next, operations that are performed by the CPU 71 to create the IGMP message management table 231 and generate the IGMP report 50 will be described in detail with reference to FIGS. 8 and 9.

FIG. 8 is a diagram illustrating an example of an operational flowchart for an IGMP message management table creation process, according to an embodiment. First, the IGMP message management table creation process will be described in detail with reference to FIG. 8. The IGMP message management table creation process may be invoked when an IGMP setting is enabled for the host 1, or when there emerges a need for creating an IGMP message management table 231.

First, the CPU 71 makes a remote connection to the switch 12 by using the address information 232 (SP1). Subsequently, the CPU 71 issues a constitution information check command (indicated as an “LAG constitution information check command” in FIG. 8) to the connected switch 12 (SP2). After having made the issuance, the CPU 71 receives, from the switch 12, information (indicated as “LAG constitution information” in FIG. 8) as a response to the command, and acquires the information (SP3). The CPU 71 stores, in the IGMP message management table 231, a port number (indicated as “port information” in FIG. 8) included in the acquired information (SP4).

In SP5 to SP10 subsequent to SP4, a process for storing a multicast address in each of entries in which the port number is stored, among entries in the IGMP message management table 231, is performed.

First, in SP5, the CPU 71 issues a distribution check command (indicated as a “LAG distribution flow check command” in FIG. 8) to the switch 12. A multicast address included in the distribution check command issued first is an address designated as an initial value in advance. After having made the issuance, the CPU 71 acquires, from the switch 12, information (indicated as “LAG distribution flow information” in FIG. 8) by receiving the information as a response to the command (SP6). The CPU 71 having acquired the information subsequently determines whether there exists a multicast address registered in an entry storing the port number included in the acquired information (SP7). When there exists no multicast address registered in entries storing the port number (NO in SP7), the process proceeds to SP8. When there exists a multicast address registered in entries storing the port number (YES in SP7), the process proceeds to SP9.

In SP8, the CPU 71 registers, in the entry storing the foregoing port number, the multicast address designated in the issued distribution check command. Then, the CPU 71 determines whether there exists an entry in which a multicast address is not registered, among all the entries storing port numbers defined in the IGMP message management table 231 (SP9). When, there exists an entry in which a multicast address is not registered, among all the entries storing the port numbers (YES in SP9), the process proceeds to SP10. When there exists no entry in which a multicast address is not registered, among all the entries storing the port numbers (NO in SP9), the IGMP message management table creation process ends.

In SP10, the CPU 71 updates the multicast address designated in the distribution check command issued most recently and decides a new multicast address to be designated in a subsequent distribution check command to be issued. Then, the process returns to SP5. Thus, a distribution check command with the newly decided multicast address is issued to the switch 12.

FIG. 9 is a diagram illustrating an example of an operational flowchart for an IGMP message generation process, according to an embodiment. Next, the IGMP message generation process will be described in detail with reference to FIG. 9. In FIG. 9, a part of the IGMP message generation process that is involved in generation of the IGMP report 50 is extracted and illustrated. In FIG. 9, as a trigger to perform this IGMP message generation process, reception of an IGMP query (indicated as an “IGMP query message” in FIG. 9) 40 is used.

Transmission of the IGMP report 50 from the host 1 is performed in the case where the router 11 is caused to recognize the existence of the host 1 belonging to the multicast group, in addition to the case where the host 1 participates in the multicast group. When the host 1 does not participate in the multicast group, the IGMP report 50 does not have to be transmitted as a response to the received IGMP query 40. Thus, reception of the IGMP query 40 is typically one of triggers to generate the IGMP report 50.

First, the CPU 71 determines whether or not the IGMP message management table 231 has been created (SP31). When no IGMP message management table 231 exists, or alternatively, when an IGMP message management table 231 in existence is not the IGMP message management table 231 for the currently connected switch 12, the determination in SP31 is NO and then the IGMP message generation process ends. On the other hand, when the IGMP message management table 231 for the currently connected switch 12 exists, the determination in SP31 is YES and the process proceeds to SP32.

When the determination in SP31 is NO and the IGMP message generation process ends, the IGMP message management table creation process illustrated in the flowchart of FIG. 8 is performed. Thus, the IGMP message management table 231 is created as appropriate.

In the example of the configuration illustrated in FIG. 2, the IGMP query 40 received by the message receiving unit 21 is handled by the IGMP message generating unit 24. When there exists no IGMP message management table 231 to be used when the IGMP query 40 is received, the IGMP message generating unit 24 controls the LAG port information retrieval unit 25 and the flow search unit 26 so as to create the IGMP message management table 231. Also, when an IGMP setting becomes enabled, the IGMP message generating unit 24 similarly controls the LAG port information retrieval unit 25 and the flow search unit 26 so as to create the IGMP message management table 231.

Description will now return to FIG. 9. In SP32, the CPU 71 resets an IGMP message generation number counter for counting the number of generated IGMP reports 50, that is, set the counter at the value “0”. This IGMP message generation number counter is implemented, for example, as a variable.

Then, the CPU 71 extracts an entry stored in the IGMP message management table 231 (SP33) and reads a multicast address from the extracted entry (SP34). The CPU 71 having read the multicast address sets the multicast address as the destination address of the IP address (SP35) and generates the IGMP report 50 (indicated as an “IGMP report message” in FIG. 9) (SP36).

Then, the CPU 71 increments the value of the IGMP message generation number counter (SP37). The CPU 71 having performed the incrementing process subsequently determines whether IGMP reports 50 have been generated for all the entries storing port numbers, in the IGMP message management table 231 (SP38). When the IGMP reports 50 for all the entries have been generated, that is, when the number of the entries storing port numbers matches the value of the IGMP message generation number counter, the determination in SP38 is YES and then the IGMP message generation process ends. When the IGMP reports 50 have not been generated for all the entries, the determination in SP38 is NO and the process returns to SP33. Thus, another entry is extracted from the IGMP message management table 231.

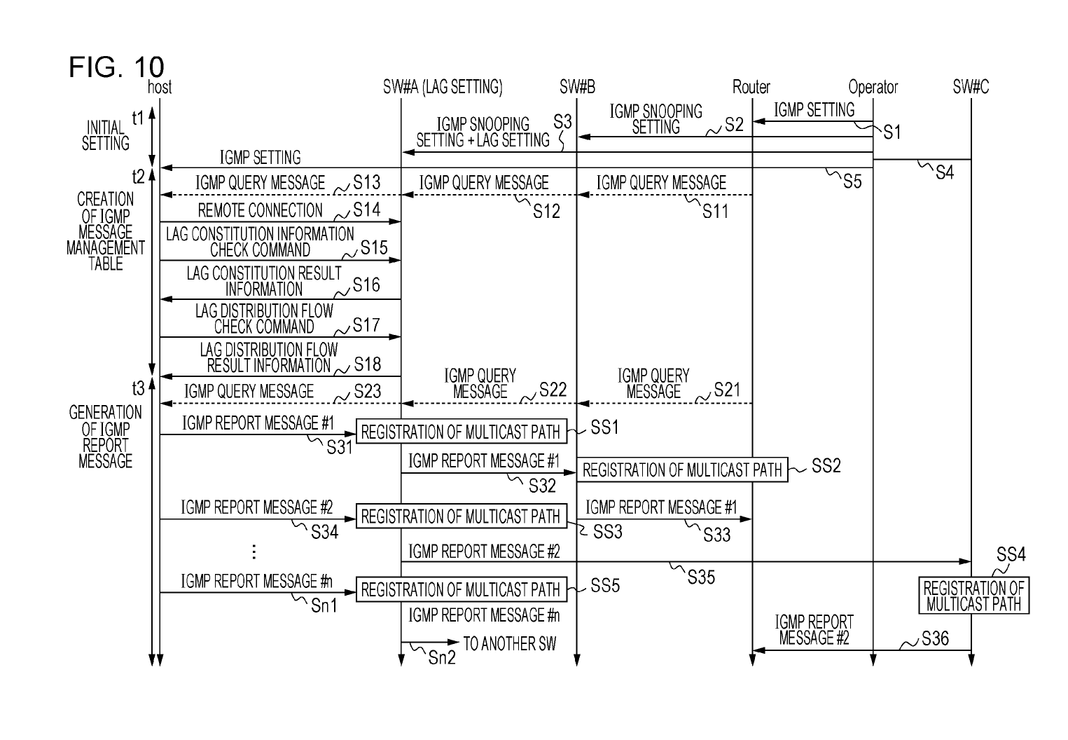

FIG. 10 is a diagram illustrating an example of an operational sequence for a host and a network connected with the host, according to an embodiment. Operations performed by the hosts 1, and the router 11 and the switches 12 that constitute the network 10 will be described with reference to FIG. 10.

“SW#A” to “SW#C” illustrated in FIG. 10 are described here as a switch 12A to a switch 12C, respectively. An operator is a worker who manages, for example, the network 10 and each host 1 connected to the network 10. A terminal device is typically used for actual tasks performed by the operator.

The operator makes, in time period t1, settings to enable an IGMP for the router 11, the switches 12A to 12C, and the host 1 which are on the network 10, and makes settings to further enable IGMP snooping for the switches 12A to 12C (S1 to S5). These processes are performed as initial setting processes.

In time period t2, an IGMP message management table 231 is created. The router 11 transmits an IGMP query 40 to the switch 12B so as to prompt the host 1 to participate in a multicast group, or to check the host 1 belonging to the multicast group (S11). This IGMP query 40 is transferred from the switch 12B to the switch 12A (S12), and then from the switch 12A to the host 1 (S13).

Here, it is assumed that the host 1 has not created the IGMP message management table 231 when the IGMP query 40 is received. Under this assumption, the host 1 makes a remote connection to the switch 12A (S14). Subsequently, the host 1 issues a constitution information check command to the switch 12A (S15), and acquires a port number of a port which is usable as a distribution destination, from the switch 12A (S16). Furthermore, the host 1 issues a distribution check command storing a designated multicast address to the switch 12A (S17), and acquires a port number of a port which is to be a distribution destination for the designated multicast address (S18). The issuance of a distribution check command and the acquisition of a port number are repeatedly made until multicast addresses are identified for all ports corresponding to port numbers acquired from the switch 12A. Then, the IGMP message management table 231 is created.

The router 11 transmits an IGMP query 40 at a predetermined time interval. In a time period t3, an IGMP query 40 is newly transferred, an IGMP report 50 is thereby generated, and the generated IGMP report 50 is transmitted. The IGMP query 40 newly transmitted by the router 11 is sequentially transferred from the router 11 to the switch 12B, from the switch 12B to the switch 12A, and from the switch 12A to the host 1 (S21 to S23).

Upon receiving the IGMP query 40, the host 1 generates IGMP reports 50 for ports which are usable as distribution destinations within the switch 12A. One of the generated IGMP reports 50 is transmitted to the switch 12A (S31), and the switch 12A having received the IGMP report 50 stores a multicast address and a port number in one entry in a multicast table 42 (SS1). Furthermore, the switch 12A transfers the received IGMP report 50 to the switch 12B (S32). Thus, as in the case of the switch 12A, the switch 12B stores the multicast address and the port number in one entry in a multicast table 42 (SS2), and transfers the received IGMP report 50 to the router 11 (S33).

Another one of the generated IGMP reports 50 is also transmitted from the host 1 to the switch 12A (S34), and the switch 12A having received the IGMP report 50 stores a multicast address and a port number in another entry in the multicast table 42 (SS3). The IGMP report 50 is transmitted from another port in the switch 12A and thereby is transferred to the switch 12C (S35).

The switch 12C receives the IGMP report 50 and stores the multicast address and the port number in one entry in a multicast table 42 (SS4). The IGMP report 50 is transferred from the switch 12C to the router 11 (S36).

Transferring an IGMP report as described above in S34 to S36 and the storing a multicast address and a port number in an entry as described above in SS4 are similarly performed for other ports provided in the switch 12A. Transfer of the IGMP report 50 in Sn1 and Sn2 and a process in SS5 are performed in the case where the host 1 transmits the last one of the generated IGMP reports 50.

In the embodiment, the host 1 accesses the switch 12 directly connected thereto by using the address information 232 stored in the storage unit 23, and generates an IGMP report 50 that is to be transmitted from each of ports usable as distribution destinations within the switch 12. This is because a switch 12 that constitutes the network 10 may be replaced or the address thereof may be changed. Thus, in the embodiment, the IGMP report 50 is generated only for the switch 12 recognized by the host 1.

For convenience of explanation, the configuration of the network 10 illustrated in FIG. 1 or the like is considerably simplified. However, in many cases, the actual configuration of the network 10 is more complicated. As the network 10 becomes more complicated, that is, as the number of the switches 12 or routers 11 is increased, the probability of occurrence of a failure increases. As the number of transfer paths to be secured is increased, the possibility that the host 1 may receive a multicast packet may be increased. Thus, address information of switches 12 to be targeted may be registered in the host 1, or alternatively, the host 1 may be configured to acquire the address information. In this case, the LAG port information retrieval unit 25 and the flow search unit 26 may be omitted.

In the embodiment, IGMP reports 50 are transmitted from all ports which are usable as distribution destinations of the IGMP reports 50 within the switch 12 to be targeted. However, the IGMP reports 50 do not have to be transmitted from all the ports which are usable as distribution destinations. Originally, the IGMP report 50 is transmitted from only one port, and transmission of the IGMP reports 50 from two or more ports allows securing a greater number of transfer paths.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for controlling a multicast communication path, the method being performed by a computer serving as a node connected to a communication network in which multiple paths are provisioned by using a plurality of transfer apparatuses each configured to perform snooping on a transferred message, the method comprising:
when participating in a multicast group, selecting, from among the plurality of transfer apparatuses, at least one first transfer apparatus each including a plurality of first ports configured to receive a first message addressed to nodes belonging to the multicast group; and
acquiring a plurality of transfer paths via which the first message is to be transferred, by:
generating, for each of the first ports provided for the at least one first transfer apparatus, a second message requesting participation in the multicast group, and
transmitting the generated second message to the at least one first transfer apparatus so that the second message is transferred via the each of the first ports.

2. An apparatus connectable, as a node, to a communication network in which multiple paths are provisioned by using a plurality of transfer apparatuses each configured to perform snooping on a transferred message, the apparatus comprising:
a memory configured to store, for at least one of the plurality of transfer apparatuses, a first address to which a first message is to be transmitted, in association with each of a plurality of first ports provided for the at least one of the plurality of transfer apparatuses, the plurality of first ports being configured to receive a first message addressed to nodes belonging to the multicast group; and
a processor configured:
to select, when participating in a multicast group, at least one first transfer apparatus from among the plurality of transfer apparatuses,
to generate, for each of a plurality of first ports provided for the at least one first transfer apparatus, a second message requesting participation in the multicast group, and
to transmit the generated second message to the selected at least one first transfer apparatus so that the second message is transferred via each of the plurality of first ports provided for the selected at least one first transfer apparatus.

3. The apparatus of claim 2, wherein
the processor communicates with the at least one first transfer apparatus and acquires port information identifying the plurality of first ports provided for the at least one first transfer apparatus;
the processor communicates with the at least one first transfer apparatus and identifies, for each of the plurality of first ports identified by the acquired port information, an address to which the first message is to be transmitted via the each of the plurality of first ports; and
the identified address is stored in the memory as the first address.

4. A computer readable recording medium having stored therein a program for causing a computer to execute a procedure, the computer being connectable, as a node, to a communication network in which multiple paths are provisioned by using a plurality of transfer apparatuses each configured to perform snooping on a transferred message, the procedure comprising:
when participating in a multicast group, selecting, from among the plurality of transfer apparatuses, at least one first transfer apparatus each including a plurality of first ports configured to receive a first message addressed to nodes belonging to the multicast group; and
acquiring a plurality of transfer paths via which the first message is to be transferred, by:
generating, for each of the first ports provided for the at least one first transfer apparatus, a second message requesting participation in the multicast group, and
transmitting the generated second message to the at least one first transfer apparatus so that the second message is transferred via the each of the first ports.
